(19) United States
(12) Patent Application Publication
(10) Pub. No.: US 2015/0217513 A1
(43) Pub. Date: Aug. 6, 2015

(54) CORRECTING BIASED DIAMETER SIZE VARIATIONS IN APERTURE ARRAY

(71) Applicant: XEROX CORPORATION, Norwalk, CT (US)

(72) Inventors: RUANDER CARDENAS, Wilsonville, OR (US); JOHN R. ANDREWS, Fairport, NY (US); TERRANCE L. STEPHENS, Canby, OR (US)

(73) Assignee: XEROX CORPORATION, Norwalk, CT (US)

(21) Appl. No.: 14/171,586

(22) Filed: Feb. 3, 2014

(51) Int. Cl. B29C 67/00

(52) U.S. Cl. CPC B29C 67/0048; B29C 2793/0045; B29L 2031/737

(57) ABSTRACT

A method of correcting aperture size variations on an aperture plate, includes characterizing variations in aperture size in an array of apertures in a nozzle plate, obtaining a transfer function that relates mask aperture size to a final ablated aperture size, and using the transfer function to create a modified imaging mask.

### BACKGROUND

Many ink jet systems dispense ink from a reservoir through a series of manifolds and chambers to an array of apertures. A stack of plates may form the manifolds and chambers, with the array of apertures taking the position in the stack closest to the print surface. The plate holding the array of apertures may be referred to as the nozzle plate, and the apertures may be referred to as jets.

In some systems, the nozzle plate may consist of a piece of polymer film with the array of apertures cut into it. Some systems use a laser and an imaging mask to cut the apertures. An imaging mask typically has a set of apertures. The process typically positions the imaging mask and imaging lens over the nozzle plate. A laser, such as an excimer laser, cuts the polymer film in the regions where the apertures exist in the imaging mask. The laser typically exposes all of the apertures within a region of the imaging mask at one time.

The apertures in the imaging mask typically have uniform aperture diameters. Due to variations in the positions of the apertures formed by the mask, the aperture elements on the nozzle plate may vary in their dimensions. The variations may result from light occlusion by the ablation debris, light/optics interactions and homogenized field intensity profile among others. The resulting nozzle plate variations result in variations in the drop size of the ink dispensed onto the print substrate. When the variations become too big, they have a negative effect on print quality.

### BRIEF DESCRIPTION OF THE DRAWINGS

FIG. 1 shows an embodiment of an imaging system.

FIG. 2 shows an embodiment of a mask imaging window displaying an array of apertures.

FIG. 3 shows a graph of row position versus aperture diameter size.

FIG. 4 shows a graph of a characterized biased variation across an embodiment of an aperture array.

FIG. 5 shows a graph of different transfer functions for different aperture positions.

FIG. 6 shows an embodiment of a mask correction.

FIG. 7 shows a graph of corrected mask aperture diameters.

FIG. 8 shows a histogram of drop mass distribution for an embodiment of a transfer function.

FIG. 9 shows a histogram of drop mass distribution for an alternative embodiment of a transfer function.

FIG. 10 shows a histogram of drop mass distribution for an embodiment of a transfer function.

FIG. 11 shows a histogram of drop mass distribution for an alternative embodiment of a transfer function.

### DETAILED DESCRIPTION OF THE EMBODIMENTS

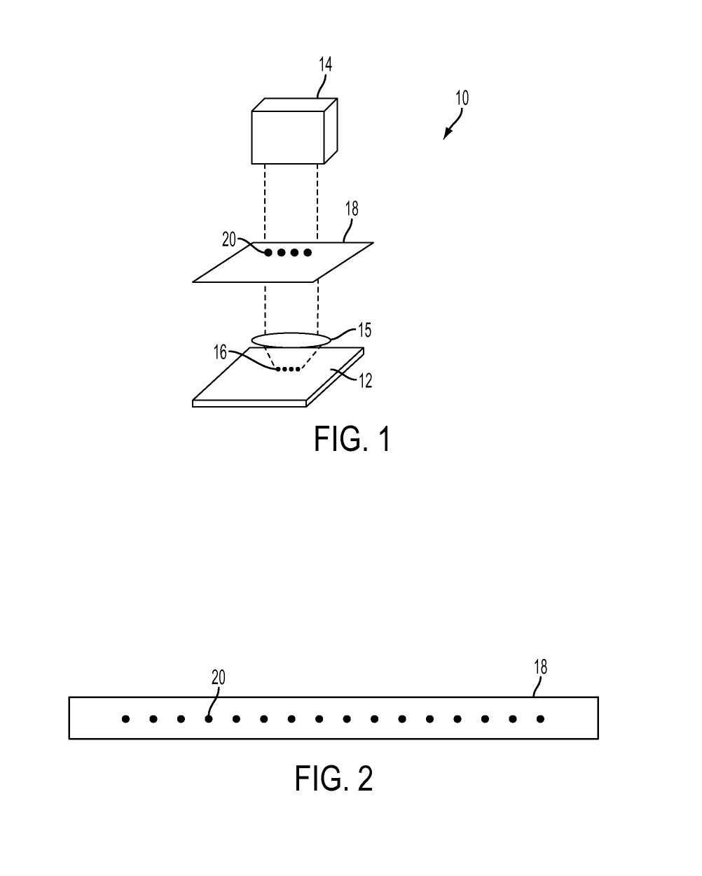

FIG. 1 shows an embodiment of a system 10 used to generate nozzle plates for printing systems, or any other films that require arrays of apertures. The system has a laser 14 that directs light onto the imaging mask 18. The laser system may include beam shaping optics or an optical system. Light passes through the apertures such as 20 on the mask 18 to form the apertures such as 16 one the film or substrate being imaged 12. In order to differentiate between the two different types of apertures, the apertures in the imaging mask may be referred to as imaging apertures, or mask apertures. The apertures in the nozzle plate will be referred to as nozzles, jets, or fluid apertures. In some cases, the beam may be shaped or imaged to reduce the light beam to image an aperture that is some factor smaller than the aperture on the mask. An imaging lens 15 may accomplish this result.

FIG. 2 shows a more detailed view of the imaging mask 18. In this particular embodiment, the mask has 20 apertures, with the understanding that the array of imaging apertures may take any form, from an array consisting of a single row of apertures to a two-dimensional array of apertures that match a complete array of jets. Typically, however, the imaging mask will consist of a smaller array than the full array of jets to be imaged. In this particular embodiment, each aperture has a diameter of 13.6 micrometers. The laser from FIG. 1 may be an ultraviolet laser that ablates a polymer that makes up the nozzle plate. The light passes through the imaging apertures such as 20, while the rest of the underlying nozzle plate remains unexposed to laser light because of the opaque area on the mask. In one embodiment, the light that passes through the mask may undergo demagnification to increase the fluence.

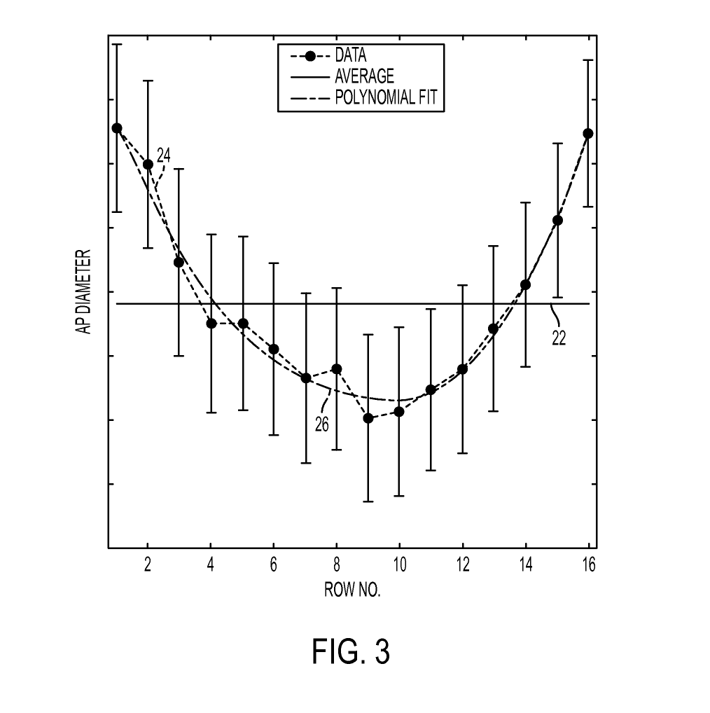

Because the imaging mask allows more than one nozzle to be imaged at a time, and the light intensity varies across the imaging mask, the resulting apertures have variations that can alter the drop mass ejected at each aperture. FIG. 3 shows the ablated diameter size variation for a 16 aperture array such as those shown in FIG. 2. The curve 22 shows the average ablated diameter over the entire data set. There exists a biased diameter size variation along the imaged window. Typically, the laser power varies with higher power towards the edges of the mask, and lower power in the middle of the array. FIG. 3 shows that data points of the actual diameters of the mask after imaging, connected by the line segments 24. The best fit curve 26 generally follows a quadratic function and the range of the average diameter values is approximately 1 micrometer.

Past systems have not addressed this problem. In current and past systems, having a variation of 1 micrometer results in about a 1-2 percent variation in the diameter. With new demands for high density print heads, the sizes of the nozzle apertures will be much smaller. Therefore, a 1 micrometer variation may result in a 10 percent or higher variation in the diameters, causing much larger variations in drop mass and lower print quality.

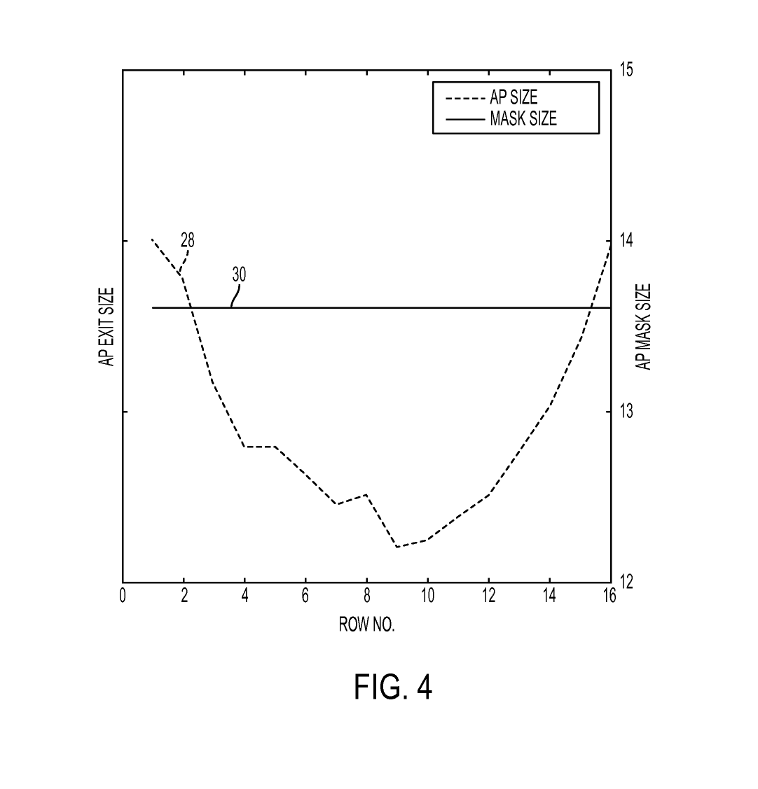

Embodiments disclosed here can correct these issues. The process typically involves a characterization process to characterize the biased variations in the aperture size for a given aperture array geometry within an imaging window. The characterization data is then used to generate a transfer function that relates the imaging aperture size to the ablated nozzle size. The ablated size variation is shown in FIG. 4 as curve 28, while the imaging aperture size is shown by the line 30. The ablated aperture exit diameter varies as a function of the position on the mask. In this particular embodiment, the position is based upon the row number in the mask. Referring to the mask in FIG. 2, the row numbers would run from left to right, from 1 to 16.

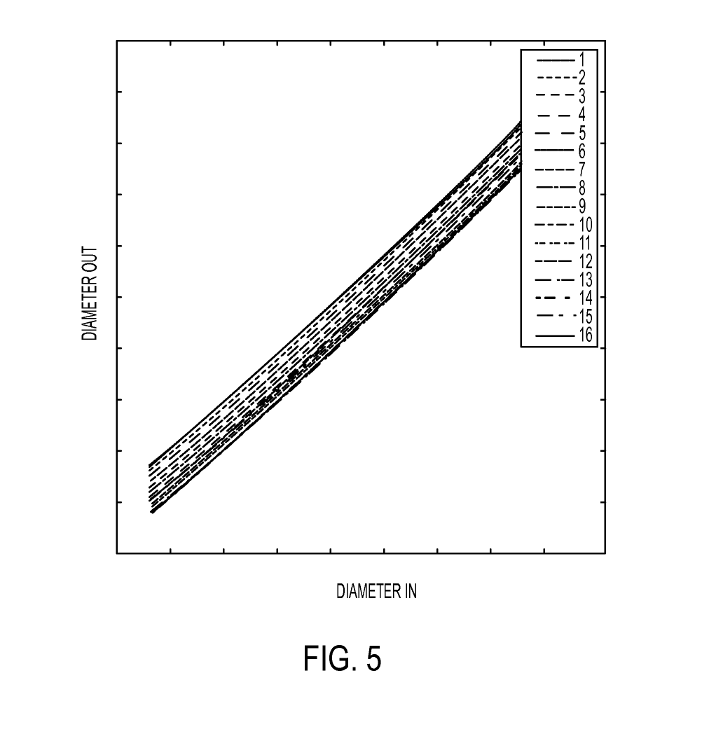

After characterizing the mask, a transfer function is obtained that relates mask aperture size and any other relevant parameters to the final ablated aperture diameter. For example, if all other parameters are fixed, at minimum the aperture size on the mask and the location on the mask affect the final ablated aperture diameter. FIG. 5 shows an example of a transfer function relating mask aperture size, diameter in, and row position, in this example 1 through 16, to the resultant ablated aperture diameter, diameter out. In this particular case, all 16 positions on the mask share the same functional relationship between diameter in and diameter out. However, since biased variations exist from position to position, the curves on FIG. 5 for each of the 16 positions are shifted up and down from one another.

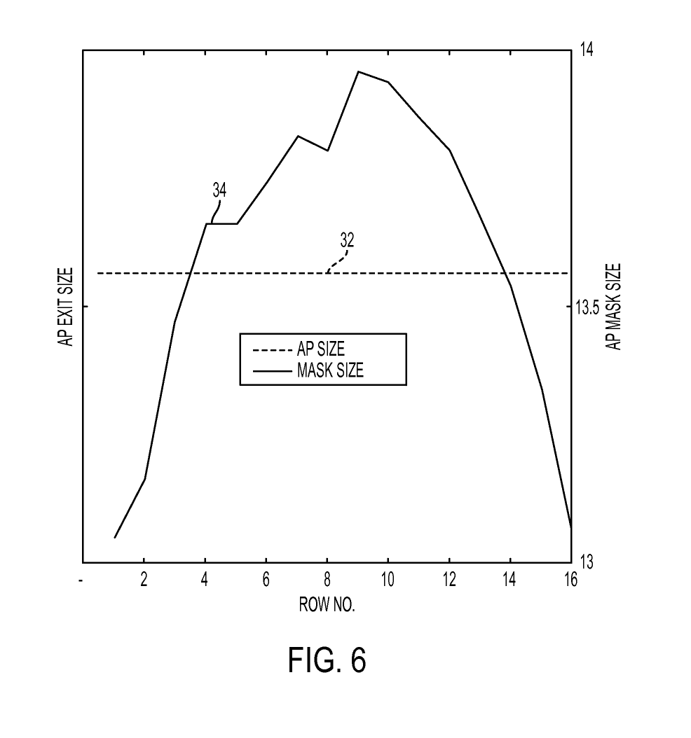

Once a transfer function has been derived, it is used to perform size corrections for each individual aperture on the mask, such that the resultant ablated aperture diameters are equal. FIG. 6 shows a result of this process. The line 32 is the resulting constant ablated aperture size. The target diameter is equal to an overall average such as those shown by the line 22 in FIG. 3, while the aperture mask size shown by curve 34 varies in a predetermined manner to make the line 32 constant at all positions on the mask.

In the embodiments shown, a constant aperture size on the mask results in a “u” shape variation in ablated diameter size with a range of about 1 micrometer. However, if each imaging aperture is corrected on the mask, the mask aperture diameter varies in an inverted “u” shape such that the resultant ablated diameter size is constant. This eliminates the variations in the nozzle aperture diameters. A u-shape is merely one example, but generally, the variations will conform to a defined shape, so the transfer function will vary as an inverse of that shape. While this may generally occur, the variations may take any form and no limitation or restriction to a defined shape is intended nor should any be implied.

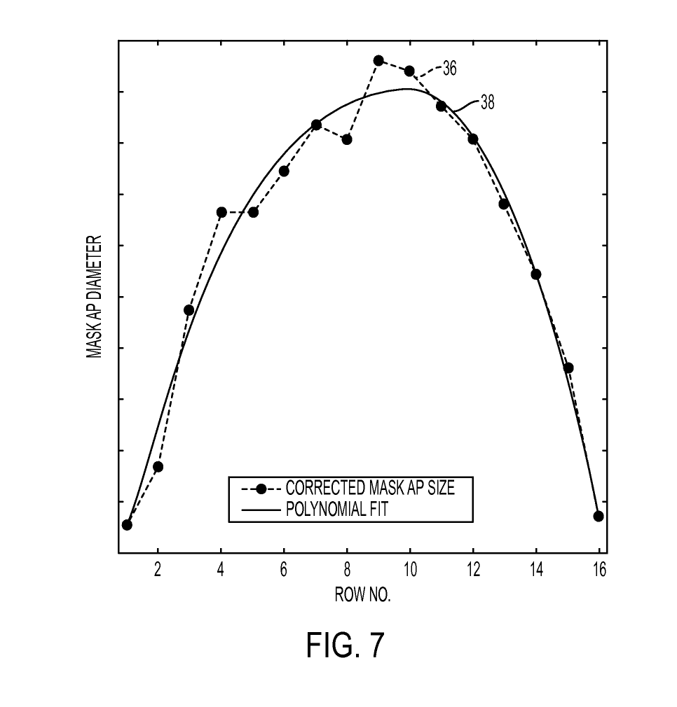

FIG. 7 shows the correct mask aperture diameters as a function of location on the imaging mask. The line segments 36 show the individual data points for the apertures, and curve 38 is the best-fit polynomial. The apertures located on both ends of the mask have smaller size than the apertures located in the middle section of the mask. This corrects for the observed trend in the original aperture diameter data when the mask was characterized. This results in nozzle apertures that are constant.

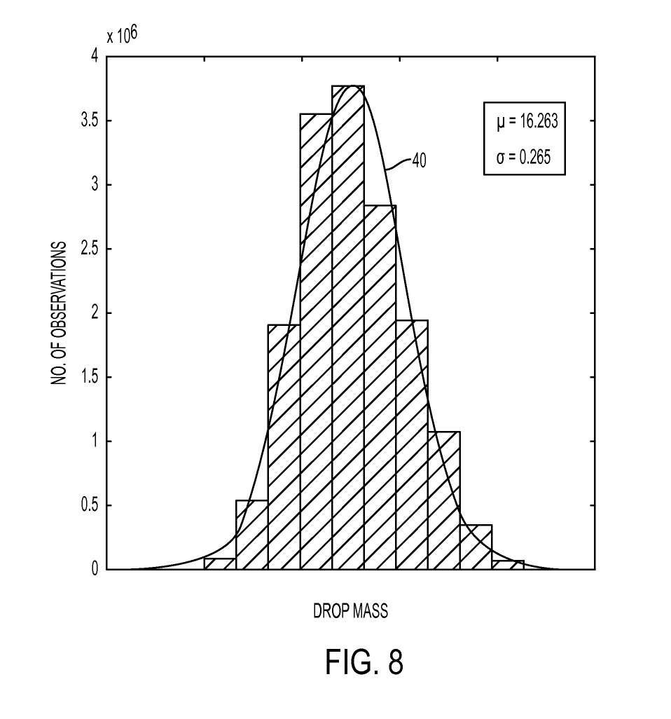

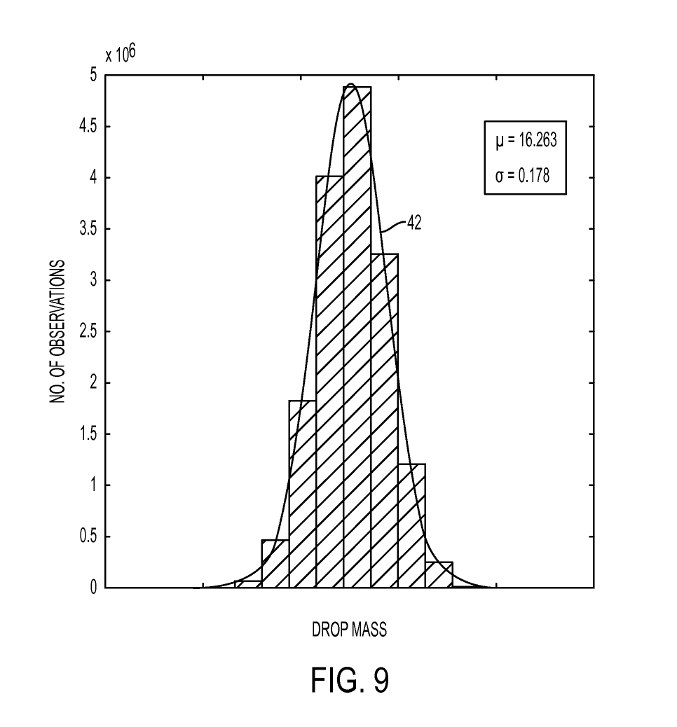

A first transfer function relating aperture size and thickness to drop mass is considered. Using this transfer function, FIG. 8 shows a histogram of the results of a numerical simulation of approximately a million possible aperture sizes from each mask position including biased variations in aperture size with curve 40 being a normal distribution with same average and standard deviation as the data set. FIG. 9 shows the same type of data in a histogram and curve 42 after correcting the mask to remove the biased variations in aperture size. One should note that the average drop mass did not change, since the average aperture diameter remained the same, the variability in the data, represented by the standard deviation was reduced by 1.5 times.

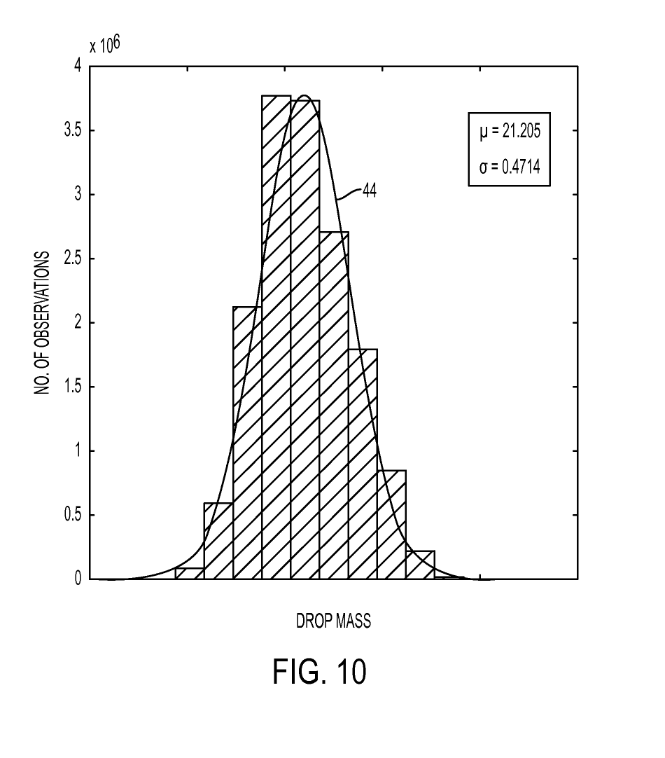

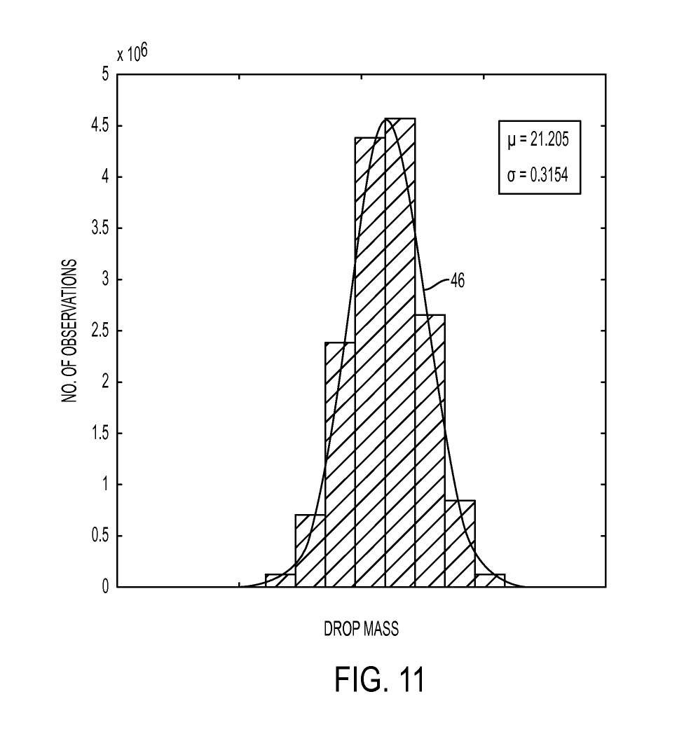

FIG. 10 shows a histogram of the result of a numerical simulation performed using a second transfer function relating aperture size and taper, and including the biased variations in aperture size. FIG. 11 shows the result of the same type of data after correcting the mask to remove the biased variations in aperture size. Again, the variability across the apertures has been reduced by 1.5 times.

In this manner, by correcting the imaging mask to correct for the variations in lighting during the imaging process, the corrected mask then produces apertures on the nozzle plate that are of constant size. This allows for the same drop mass for each aperture. As the density of the aperture arrays on the nozzle plates increases, and the apertures shrink in size, the effect of any variation reduces the print quality. The embodiments here can alleviate that problem to ensure constant aperture sizes.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of correcting aperture size variations on an aperture plate, comprising:
characterizing variations in aperture size in an array of apertures in a nozzle plate;
obtaining a transfer function that relates mask aperture size to a final ablated aperture size; and
using the transfer function to create a modified imaging mask.

2. The method of claim 1, further comprising using the transfer function to estimate the appropriate aperture size prior to creating the final ablated apertures.

3. The method of claim 1, wherein characterizing variations further comprises measuring the aperture diameters.

4. The method of claim 1, wherein using the transfer function to create a modified imaging mask comprises forming apertures in the imaging mask according to the transfer function.

5. The method of claim 4, wherein forming the apertures in the imaging mask results in apertures of varying dimensions, where the apertures vary according to the transfer function.

6. The method of claim 1, further comprising imaging a nozzle plate using the modified imaging mask.

7. An imaging mask, comprising:
an array of apertures, wherein at least one dimension of the apertures vary across the array according to a transfer function.

8. The imaging mask of claim 7, wherein the dimension comprises the diameter of the apertures.

9. The imaging mask of claim 7, wherein the transfer function causes the dimension to vary across the array according to a defined functional relationship.
